(19) United States
(12) Patent Application Publication
(10) Pub. No.: US 2008/0235092 A1
(43) Pub. Date: Sep. 25, 2008

(54) METHOD OF ADVERTISING WHILE PLAYING MULTIMEDIA CONTENT

(75) Inventors: Ki Ho Song, Seoul (KR); Byounghak Kim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-si (KR)

(21) Appl. No.: 12/052,602

(22) Filed: Mar. 20, 2008

(30) Foreign Application Priority Data
Mar. 21, 2007 (KR) 10-2007-0027743

(51) Int. Cl. G06Q 30/00

(52) U.S. Cl. 705/14

(57) ABSTRACT

An advertising method and system displaying a context advertisement when the context advertising associated with a contents page which does not match with an advertising keyword or has no text, is provided. The advertising method which displays context advertising information includes: maintaining a context advertising database including the context advertising information; maintaining a user input keyword database including an input query set of keywords inputted by a user; and retrieving and displaying context advertising information associated with the input query set from the context advertising database, when the user visits a contents page which does not match with an advertising keyword or has no text.

### CROSS-REFERENCE TO RELATED APPLICATION

This application claims the benefit of Korean Patent Application No. 10-2007-0027743, filed on Mar. 21, 2007, in the Korean Intellectual Property Office, the disclosure of which is incorporated herein by reference in its entirety.

### BACKGROUND

1. Field

The present disclosure relates to a method of advertising, and more particularly, to a method of advertising while playing multimedia content. displays

2. Description of Related Technology

Generally, context advertising is different from keyword advertising using a query provided by a search portal site. Keyword advertising refers to advertising linked to a specific word or phrase. Specifically, in keyword advertising, since an advertiser or advertising agent registers a keyword representing a web site or product of advertiser's company, an advertisement of the advertiser registering the keyword is displayed as a search result when a user inputs the keyword in a search window. Context advertising displays an advertisement of an advertiser on various types of contents pages provided by a search portal site, and thus the advertisement may be displayed to users more easily. Context advertising displays an advertisement most highly associated with a contents page, and is provided to users in an advertisement search portal site.

Typically, a contents page with context advertising is mainly a contents-based text contents page. However, context advertising information is currently required to be displayed on various types of contents pages including cartoons, music, movies, and the like, as well as the text contents page. A contents-based determination method is used to appropriately display advertisements associated with an existing text-based contents page. A contents-based determination method includes a keyword matching method such as an extended search using word information. In an extended search, a website advertisement is provided when a query inputted by a user includes a keyword registered by an advertiser or a word order is different.

The foregoing discussion in this section is to provide general background information, and does not constitute an admission of prior art.

### SUMMARY

One aspect of the invention provides a method of advertising, which comprises: recognizing that a user's terminal is playing or initiating to play a multimedia content transmitted from a website; providing data indicative of the user's interactions with the Internet before playing or initiating to play the multimedia content; analyzing the data so as to draw an advertisement keyword relating to the user's interactions with the Internet; selecting at least one advertisement based on the advertisement keyword; and transmitting the at least one advertisement for displaying on the user's terminal while playing the multimedia content.

In the foregoing method, the user's interactions may comprise at least one of searching with a search query and visiting a webpage, wherein the user visited webpage may have a URL and a content description of the webpage. The data indicative of the user's interaction may comprise at least one selected from the group consisting of the search query, the URL and the content description. Analyzing the data may comprise identifying a plurality of terms from the data, and drawing the advertisement keyword among the identified plurality of terms based on a relevancy value assigned to each term. The relevancy value may be assigned based on at least one selected from the group consisting of how many times each identified term occurs in the data, and how close in time an occurrence of each identified term is to playing of the multimedia content. The more each term occurs, the greater the relevancy value assigned to the identified term is. The closer in time each identified term's occurrence is to playing of the multimedia content, the greater the relevancy value assigned to the identified term is. The relevancy value assigned to each identified term may be the sum of time proximity values of occurrences thereof. The longer a time gap between an occurrence and playing of the multimedia content, the smaller the time proximity value is. The relevancy value may represent a degree of relevancy of each identified term to the multimedia content. The term having the highest relevancy value may be drawn as the advertisement keyword.

Still in the foregoing method, analyzing the data comprises: identifying a plurality of terms from the data; and searching each identified term from a list of plurality of advertisement keywords so as to locate a plurality of advertisement keywords; drawing one among the plurality of advertisement keywords based on a relevancy value assigned to each term. The relevancy value may be assigned based on at least one selected from the group consisting of how many times each of the plurality of advertisement keywords occurs in the data, and how close in time an occurrence of each of the plurality of advertisement keywords is to playing of the multimedia content, wherein the more each advertisement keyword occurs, the greater the relevancy value assigned to the advertisement keyword is, wherein the closer in time each advertisement keyword's occurrence is to playing of the multimedia content, the greater the relevancy value assigned to the advertisement keyword is, wherein the relevancy value assigned to each advertisement keyword is the sum of time proximity values of occurrences thereof, wherein the longer a time gap between an occurrence and playing of the multimedia content, the smaller the time proximity value is.

Further in the foregoing method, selecting the advertisement may comprise locating the at least one advertisement associated with the advertisement keyword that is sold to at least one advertiser for displaying the at least one advertisement when the advertisement keyword is selected. Recognizing may comprise at least one selected from the group consisting of monitoring types and sizes of data transmission between a server of the website and the user's terminal, monitoring operation of the user's terminal, receiving from a server of the website information about playing or initiating to play the multimedia content in the user's terminal, and receiving from the user's terminal information about playing or initiating to play the multimedia content. The types of data transmission may comprise streaming, downloading from the server to the user's terminal, uploading from the user's terminal to the server, wherein the information received from the user's terminal or the server comprises at least one selected from the group consisting of a request for streaming or downloading the multimedia content, an acknowledgement of receipt of the request, and a notification of streaming or downloading progress. Recognizing may comprise determining that the multimedia content transmitted from a website is being played or about to be played. Providing data may comprise monitoring user's interactions with the Internet. Providing data may comprise receiving, from the user's terminal, data indicative of user's interactions with the Internet. The data may represent the user's interactions with the Internet for a predetermined period up to playing of the multimedia content.

An aspect of the present invention provides an advertising method and system displaying context advertising information associated with a contents page where a contents-based determination method may not be used, when the context advertising information associated with the contents page which does not match with an advertising keyword, or has no text, for example, cartoons, music, and movies, is displayed.

Another aspect of the present invention provides an advertising method and system displaying context advertising information which maintains a context advertising database and a user input keyword database, retrieves and displays context advertising information associated with a keyword inputted by a user, and thereby may analyze user information and display context advertising where a contents-based determination method may not be used on a contents page.

According to an aspect of the present invention, there is provided an advertising method which displays context advertising information, the advertising method comprising maintaining a context advertising database including the context advertising information; maintaining a user input keyword database including an input query set of keywords inputted by a user; and retrieving and displaying context advertising information associated with the input query set from the context advertising database, when the user visits a contents page which does not match with an advertising keyword or has no text.

According to an aspect of the present invention, the advertising method which displays context advertising information further comprises maintaining a navigation database including webpage information of a webpage the user visits.

According to another aspect of the present invention, there is provided an advertising method which displays context advertising information, the advertising method comprising maintaining a context advertising database including the context advertising information; maintaining a user input keyword database including an input query set of keywords inputted by a user; maintaining a navigation database including an extraction query set of keywords extracted from a webpage the user visits; and retrieving and displaying context advertising information associated with the input query set and the extraction query set from the context advertising database, when the user visits a contents page which does not match with an advertising keyword or has no text.

According to still another aspect of the present invention, there is provided an advertising system which displays context advertising information, the advertising system comprising a context advertising database including the context advertising information; a user input keyword database including an input query set of keywords inputted by a user; and a retrieval exposure unit retrieving, from the context advertising database, and displaying context advertising information associated with the input query set when the user visits a contents page which does not match with an advertising keyword or has no text.

According to yet another aspect of the present invention, there is provided an advertising system which displays context advertising information, the advertising system comprising a context advertising database including the context advertising information; a user input keyword database including an input query set of keywords inputted by a user; a navigation database including an extraction query set of keywords extracted from a webpage the user visits; and a retrieval exposure unit retrieving, from the context advertising database, and displaying context advertising information associated with the input query set and the extraction query set when the user visits a contents page which does not match with an advertising keyword or has no text.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating a schematic configuration of an advertising system which displays context advertising information according to an embodiment of the present invention;

FIG. 2 is a flowchart illustrating an advertising method which displays context advertising information according to an embodiment of the present invention;

FIG. 3 is a diagram illustrating an example of a context advertising database according to an embodiment of the present invention;

FIG. 4 is a diagram illustrating an example of a user input keyword database according to an embodiment of the present invention;

FIG. 5 is a diagram illustrating an example of a navigation database according to an embodiment of the present invention;

FIG. 6 is a flowchart illustrating an advertising method which displays context advertising information according to another embodiment of the present invention;

FIG. 7 is a diagram illustrating an example of displaying context advertising information according to an embodiment of the present invention; and

FIG. 8 is a diagram illustrating a configuration of an advertising system which displays context advertising information according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout.

Context advertising using the above-described contents-based determination method may not be applied to a contents page which does not match with an advertising keyword, or has no text, for example, cartoons, music, and movies. A method where context advertising information is registered by an advertiser and the context advertising information is displayed at a particular time may be provided. However, context advertising information of several context advertisings is randomly displayed on a limited advertising area, and thus the context advertising information may not attract attention and an advertising effect decreases.

Another advertising method which determines optimal context advertising information and provides the optimal context advertising information for a predetermined period of time may be provided. However, it is difficult to understand a correlation between context advertising information and a contents page in order to determine the optimal context advertising information.

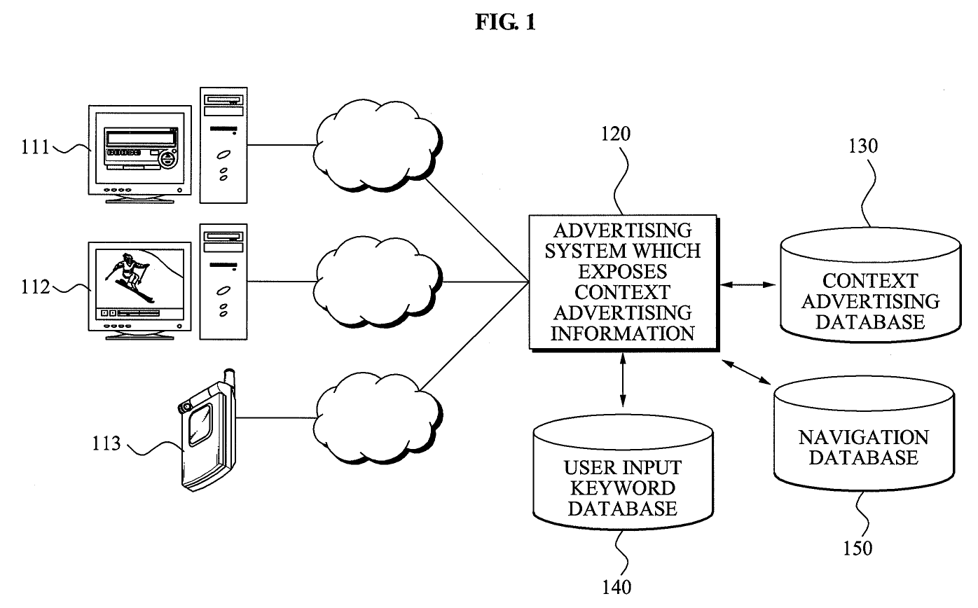

FIG. 1 is a diagram illustrating a schematic configuration of an advertising system 120 which displays context advertising information according to an embodiment of the present invention.

As illustrated in FIG. 1, the advertising system 120 may display the context advertising information, optimally associated with contents pages, to users 111, 112, and 113. The users 111, 112, and 113 visit the contents pages which do not match with an advertising keyword or have no text. Specifically, the user 111 visits a contents page provided as music, and the user 112 or the user 113 visits a contents page provided as video.

To display the context advertising information optimally associated with contents pages which do not match with the advertising keyword or have no text to the users 111, 112, and 113, the advertising system 120 may retrieve, from a user input keyword database 140, and display the context advertising information associated with an input query set of keywords inputted by the users 111, 112, and 113 in at least one search portal site before visiting the contents page.

According to another embodiment of the present invention, to display to the users 111, 112, and 113 the context advertising information optimally associated with contents pages which do not match with the advertising keyword or have no text, the advertising system 120 may retrieve and display context advertising information most highly associated with the input query set and an extraction query set with respect to the contents page. The input query set is inputted by the users 111, 112, and 113, and included in the user input keyword database, and the extraction query set is extracted from a navigation database.

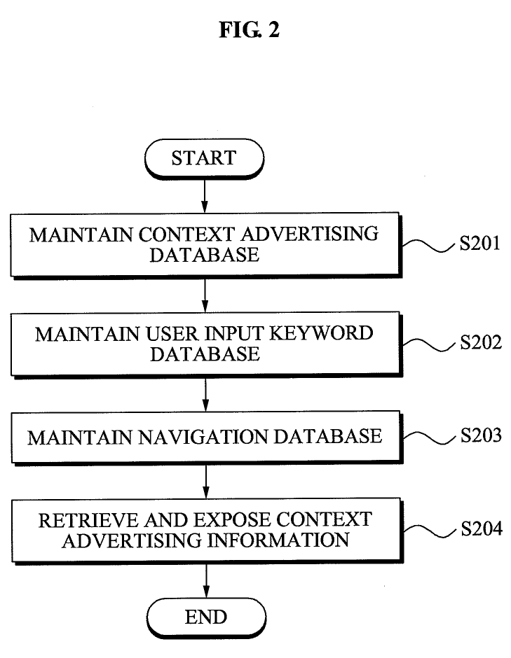

FIG. 2 is a flowchart illustrating an advertising method which displays context advertising information according to an embodiment of the present invention. The advertising method which displays context advertising information is performed as illustrated in FIG. 2.

In operation S201, an advertising system which displays context advertising information may maintain a context advertising database including the context advertising information. The context advertising refers to advertising which displays advertising information optimally associated with each of various types of contents pages to a user in association with each of the contents pages. For example, an advertisement of a mobile phone company or a shopping mall selling the mobile phone is inserted below a user's comment on the mobile phone, and thus the advertisement is displayed to users interested in a corresponding product such as the mobile phone. The user's comment may be a type of a character contents page.

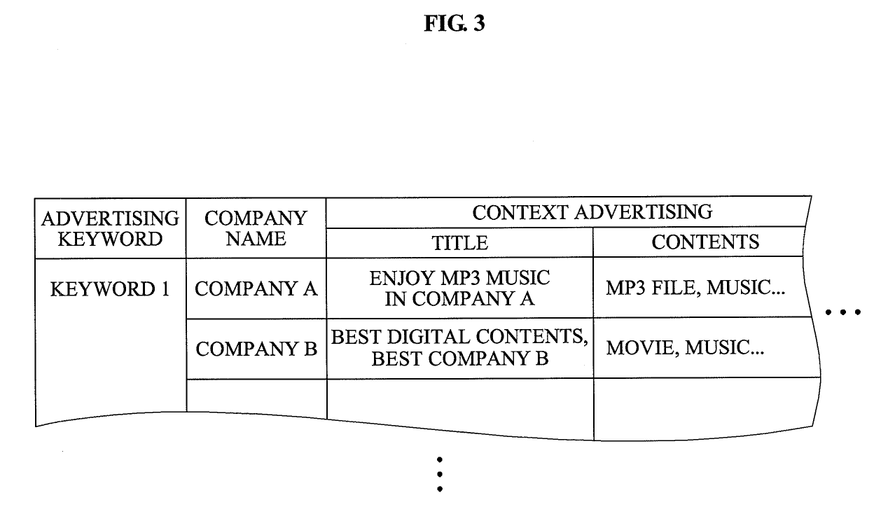

The contents page includes a webpage including contents or information about characters, symbols, sounds, voices, images, and videos digitally produced, processed, and distributed to be used on the Internet. The maintaining in operation S201 is described in greater detail with reference to FIG. 3.

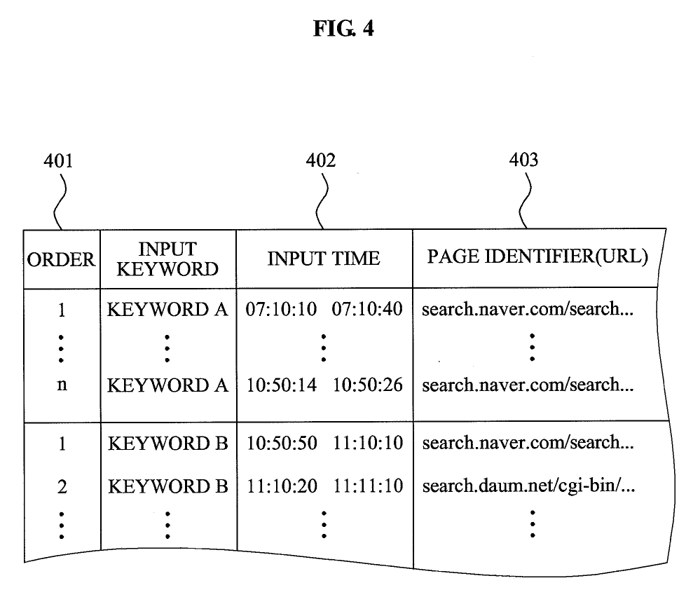

In operation S202, the advertising system may maintain a user input keyword database including an input query set of keywords inputted by a user. The keyword may be extracted from the keywords inputted by the user via at least one search site. The input query set may refer to a set of a plurality of queries, and a lexical meaning of the query is a question. Currently, the query may refer to a query phrase inputted in a search input box on various search sites as an Internet terminology. Particularly, in certain embodiments of the present invention, the query may refer to a keyword. However, the query is not limited to the keyword and may include a query sentence and keywords extracted from the query sentence. The maintaining in operation S202 is described in greater detail with reference to FIG. 4.

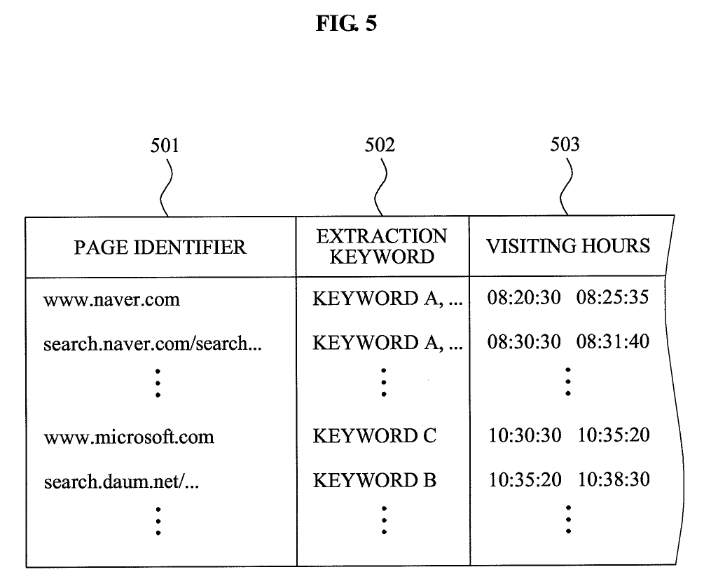

In operation S203, the advertising system may maintain a navigation database including webpage information of at least one webpage the user visits. The webpage information may include a page identifier, at least one keyword extracted from the at least one webpage, and a visiting hour of the at least one webpage. The page identifier may be a uniform resource locator (URL) address of the at least one webpage the user visits. The maintaining in operation S203 is described in greater detail with reference to FIG. 5.

In operation S204, the advertising system may retrieve and display context advertising information associated with the input query set from the context advertising database, when the user visits a contents page which does not match with an advertising keyword or has no text. The contents page which does not match with the advertising keyword or has no text may indicate that the contents page has no character type text, or a keyword matching is not performed in the contents page through information about the character type text although the contents page includes the character type text.

In the keyword matching, word information is extracted from text contents of corresponding contents and an optimal keyword representing the contents is determined based on the word information. The keyword matching may be referred to as a keyword extraction method using a content-based classification. In the keyword extraction method using a content-based classification, a keyword highly associated with a character type contents page is extracted, and thus the keyword may represent the character type contents page. Also, in the keyword extraction method, actual contents of the character type contents page is analyzed, a subject word list including a plurality of subject words is extracted from the character type contents page, a source of the character type contents page, and the like, are analyzed, a portion irrelevant to the actual contents, such as an advertisement, is identified, only a subject word excluding the identified portion is extracted, an optimal subject word is determined through various determination processes associated with the subject word, and the optimal subject word is determined as the keyword for the keyword matching.

In operation S204, the advertising method may include an operation of determining whether the user visits the contents page which does not match with the advertising keyword or has no text. Further, when the user visits the contents page which matches with the advertising keyword through the determining described above, the advertising system may extract the optimal keyword through the keyword extraction method using the content-based classification, retrieve the context advertising information associated with the extracted keyword from the context advertising database, and display the context advertising information.

In operation S204, to retrieve and display the context advertising information associated with the input query set from the context advertising database, the advertising system may determine a correlation between the input query set and the context advertising information using various correlation determination methods. As an example of the correlation determination methods, the advertising system may determine a representative keyword from among at least one keyword included in the input query set, retrieve the representative keyword from the context advertising database, and display context advertising information matching with the representative keyword. The representative keyword is identical to the advertising keyword included in the context advertising database. However, other correlation determination methods excluding the above-described method may exist, and certain embodiments of the present invention may include other correlation determination methods.

The advertising system may apply a variety of methods of determining the representative keyword. According to an embodiment of determining the representative keyword, the advertising system may analyze a weight proportional to an input frequency with respect to each of user input keyword, and determine a keyword having a greatest weight as the representative keywords. However, other representative keyword determination methods excluding the above-described method may exist, and certain embodiments of the present invention may include other representative keyword determination methods.

When the context advertising information matching with the representative keyword may not be retrieved from the context advertising database, that is, when the advertising keyword identical to the representative keyword is not included in the context advertising database, the advertising system may retrieve an advertising keyword associated with the representative keyword, and display context advertising information matching with the advertising keyword through a correlation keyword search. For the correlation keyword search, the advertising system determines the correlation between the representative keyword and the at least one advertising keyword matching with context advertising information, and may display the context advertising information associated with the advertising keyword. The at least one advertising keyword is included in the context advertising database. The correlation determination methods include a method of determining whether characters are similar or included in the advertising keyword. Also, the advertising system may include a keyword correlation determination unit including a storage unit and an analysis unit. The storage unit stores information for the keyword correlation determination and the analysis unit analyzes the correlation.

To collect the information for the keyword correlation determination, a first keyword is determined from among at least one keyword inputted by the user or extracted from a webpage the user visits, a second keyword from among the at least one keyword excluding the first keyword is determined, the first keyword and the second keyword are paired, accumulated values with respect to each of at least one pair of the first keyword and the second keyword are compared, and a correlation of each of the at least one keyword is analyzed. However, other methods to collect the information for the keyword correlation determination excluding the above-described method may exist, and certain embodiments of the present invention may include other methods.

In operation S204, the advertising system may assign a greater weight to a more recently inputted keyword from among the keywords, inputted by the user and included in the input query set, retrieve and display the context advertising information according to the assigned weight. FIG. 4 illustrates the user input keyword database. However, the user input keyword database is not limited the configuration illustrated in FIG. 4, and may be maintained in various configurations to include the input query set. The user input keyword database illustrated in FIG. 4 includes a page identifier and an input time of an input keyword inputted by the user in a search site, and the like. When using the input time, the weight may be assigned to a recently inputted keyword.

According to an embodiment of assigning the weight, when a keyword A is inputted an n number of times, it is determined whether an input time of the keyword A is recent with respect to a first time, a second time, and an nth time that the keyword A is inputted, for example, ten minutes before or twenty minutes before. As non-limiting examples, when the input time corresponds to ‘ten minutes before’, a weight is determined as a, when the input time corresponds to ‘twenty minutes before’, a weight is determined as b, and when the input time corresponds to ‘one hour before’, a weight is determined as c. Also, the weights a through n are summed, and the sum may be determined as a final value of the keyword A. The greater weight may be determined as the input time is more recent. A final value is determined depending on each of the keywords A through N, the final value of each of the keywords A through N is analyzed, for example, a method of determining a keyword having a greatest final value as a representative keyword, and thus the representative keyword may be determined.

According to another embodiment of the present invention, in operation S204, the advertising system may assign the weight to the keywords, inputted by the user and included in the input query set, retrieve and display the context advertising information according to the assigned weight. The weight is determined according to webpage information of a webpage the user visits. FIG. 5 illustrates a navigation database including the webpage information of the webpage the user visits. However, the navigation database is not limited to the configuration illustrated in FIG. 5, and may be maintained in various configurations to include the webpage information. The webpage information may include a page identifier, an extraction keyword extracted from the webpage, and a visiting hour. When using information about the visiting hour, the weight may be assigned to the keyword inputted by the user according to the visiting hour of the webpage.

To assign the weight depending on the visiting hour, the advertising system determines whether the user visits a webpage including the keyword A and a visiting hour of the webpage the user visits, for example, one minute, two minutes, or ten minutes. When the visiting hour corresponds to ‘one minute’, a weight is determined as a, when the visiting hour corresponds to ‘two minutes’, a weight is determined as b, and when the visiting hour corresponds to ‘ten minutes’, a weight is determined as c. Also, the weights are summed, and the sum may be determined as a final value of the keyword A. The longer the visiting hour lasts, the larger the weight may be set. The final value is determined depending on each of the keywords A through N, the final value of each of the keywords A through N is analyzed, for example, the method of determining the keyword having the greatest final value as the representative keyword, and thus the representative keyword may be determined.

FIG. 3 is a diagram illustrating an example of a context advertising database according to an embodiment of the present invention. The context advertising database may include the context advertising information which is selected by an advertiser and advertising agent, and is desired to be displayed on the contents page. Also, the context advertising database may include a company name and advertising keyword identifying the advertiser and advertising agent. As described above, the advertising keyword may be used to determine the correlation with the advertising keyword and the representative keyword from the input query set including the user input keyword.

FIG. 4 is a diagram illustrating an example of a user input keyword database according to an embodiment of the present invention. The user input keyword database may include an order 401, input time 402, and page identifier 403. An input frequency of each input keyword A through N may be determined using the order 401. Address information of a webpage where the input keyword is inputted may be ascertained using the page identifier 403. As described above, the input time 402 may be used as determination information to assign a greater weight to a more recently used keyword when context advertising information associated with keywords, inputted by a user and included in an input query set, is retrieved.

FIG. 5 is a diagram illustrating an example of a navigation database according to an embodiment of the present invention. The navigation database may include a page identifier 501, extraction keyword 502, and visiting hour 503. An address of a webpage that a user visits may be identified through the page identifier 501. As described above, when context advertising information associated with keywords, inputted by a user and included in an input query set, is retrieved, the extraction keyword 502 and visiting hour 503 may be used as determination information for determining a weight according to the visiting hour of the webpage the user visits.

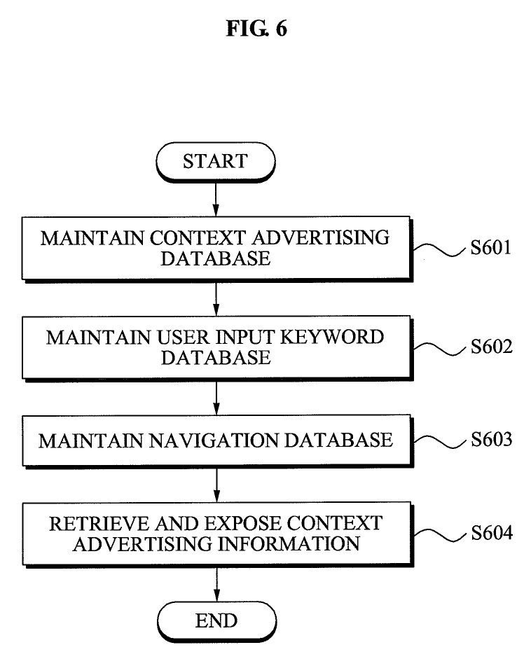

FIG. 6 is a flowchart illustrating an advertising method which displays context advertising information according to another embodiment of the present invention. As illustrated in FIG. 6, the advertising method may be performed in operations S601 through S604. An operation of maintaining a context advertising database in operation S601 and an operation of maintaining a user input keyword database in operation S602 may be performed in a same way as the maintaining of a context advertising database in operation S201 and the maintaining of a user input keyword database in operation S202 of FIG. 2, respectively.

In operation S603, an advertising system may maintain a navigation database including an extraction query set of keywords extracted from a webpage a user visits. The navigation database may include a page identifier of the webpage, an extraction keyword extracted from the webpage, and a visiting hour of the webpage. To extract the keywords from the webpage, the advertising system may analyze word information included in the webpage. Also, a word which is insignificantly associated with the webpage may be excluded from the word information.

In operation S604, the advertising system may retrieve and display context advertising information associated with the input query set and the extraction query set from the context advertising database, when the user visits a contents page which does not match with an advertising keyword or has no text. The advertising system extracts at least one keyword, for example, a keyword A through keyword N, from input keywords included in the user input keyword database and extraction keywords included in the navigation database. Also, the advertising system may assign a weight to the at least one keyword, retrieve and display the context advertising information according to the weight. The weight may be determined based on webpage information of the webpage the user visits, input time of the keywords inputted by the user, and input frequency of the keywords inputted by the user.

Specifically, the advertising system extracts the at least one keyword from the input keywords included in the user input keyword database and the extraction keywords included in the navigation database. Also, the advertising system assigns the weight with respect to each of the extracted keywords, determines a representative keyword from among the extracted keywords, determines a correlation between the representative keyword and advertising keyword included in the context advertising database, and displays the context advertising information associated with the representative keyword.

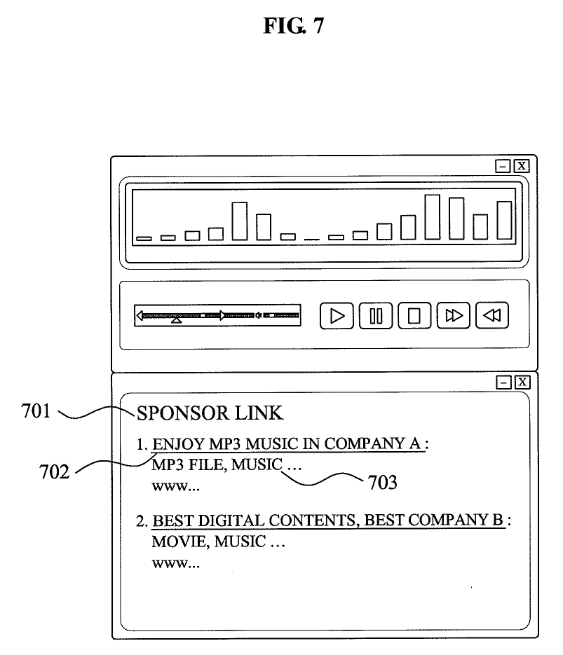

FIG. 7 is a diagram illustrating an example of displaying context advertising information according to an embodiment of the present invention. FIG. 7 illustrates a contents page which does not match with an advertising keyword or has no text. The contents page of FIG. 7 provides music. An advertising system may display context advertising when a user visits the contents page. Context advertising information may be displayed as various characters and videos. Information 701, an advertising title 702, and contents 703 representing the context advertising are illustrated in FIG. 7. The advertising title 702 and contents 703 may be extracted from a context advertising database illustrated in FIG. 3.

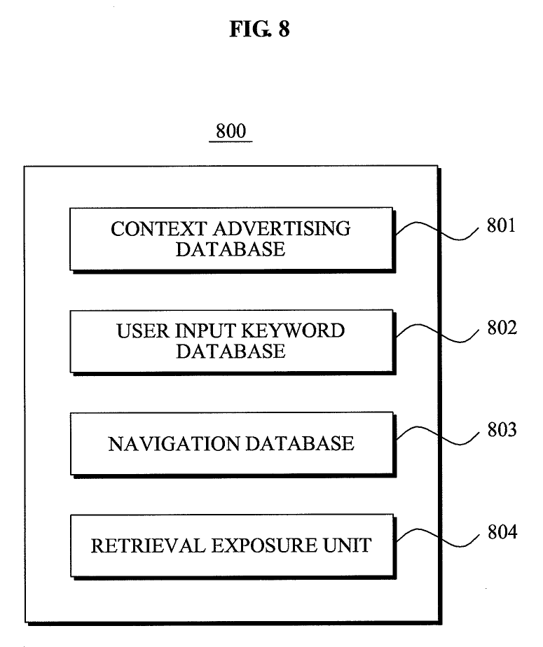

FIG. 8 is a diagram illustrating a configuration of an advertising system 800 which displays context advertising information according to an embodiment of the present invention. As illustrated in FIG. 8, the advertising system 800 may include a context advertising database 801, a user input keyword database 802, a navigation database 803, and a retrieval exposure unit 804.

The advertising system 800 may maintain the context advertising database 801 including the context advertising information. The advertising system 800 may maintain the user input keyword database 802 including an input query set of keywords inputted by a user. The advertising system 800 may maintain the navigation database 803 including webpage information of at least one webpage the user visits. The retrieval exposure unit 804 may retrieve and display context advertising information associated with the input query set from the context advertising database 801, when the user visits a contents page which does not match with an advertising keyword or has no text.

The advertising method which displays context advertising information according to the above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for certain embodiments of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an advertising method and system displaying context advertising information associated with an input query set inputted by a user, when a context advertising is provided to a contents page which does not match with an advertising keyword or has no text, a highly associated context advertising according to a correlation based on information about the user is displayed on a corresponding contents page, and thus an advertising exposure area may be extended, a navigation exposure system may be applied, and a profit of an advertiser may increase.

Also, according to an advertising method and system displaying context advertising information, a user may be quickly provided with necessary advertising information associated with corresponding contents, and thus information may be easily provided, and the user may easily and efficiently buy a product related to the contents.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of advertising comprising:
recognizing that a user's terminal is playing or initiating to play a multimedia content transmitted from a website;
providing data indicative of the user's interactions with the Internet before playing or initiating to play the multimedia content;
analyzing the data so as to draw an advertisement keyword relating to the user's interactions with the Internet;
selecting at least one advertisement based on the advertisement keyword; and
transmitting the at least one advertisement for displaying on the user's terminal while playing the multimedia content.

2. The method of claim 1, wherein the user's interactions comprises at least one of searching with a search query and visiting a webpage, wherein the user visited webpage has a URL and a content description of the webpage.

3. The method of claim 2, wherein data indicative of the user's interaction comprises at least one selected from the group consisting of the search query, the URL and the content description.

4. The method of claim 2, wherein analyzing the data comprises:
identifying a plurality of terms from the data; and
drawing the advertisement keyword among the identified plurality of terms based on a relevancy value assigned to each term.

5. The method of claim 4, wherein the relevancy value is assigned based on at least one selected from the group consisting of how many times each identified term occurs in the data, and how close in time an occurrence of each identified term is to playing of the multimedia content.

6. The method of claim 5, wherein the more each term occurs, the greater the relevancy value assigned to the identified term is.

7. The method of claim 5, wherein the closer in time each identified term's occurrence is to playing of the multimedia content, the greater the relevancy value assigned to the identified term is.

8. The method of claim 5, wherein the relevancy value assigned to each identified term is the sum of time proximity values of occurrences thereof.

9. The method of claim 8, wherein the longer a time gap between an occurrence and playing of the multimedia content, the smaller the time proximity value is.

10. The method of claim 4, wherein the relevancy value represents a degree of relevancy of each identified term to the multimedia content.

11. The method of claim 4, wherein the term having the highest relevancy value is drawn as the advertisement keyword.

12. The method of claim 2, wherein analyzing the data comprises:
identifying a plurality of terms from the data; and
searching each identified term from a list of plurality of advertisement keywords so as to locate a plurality of advertisement keywords;
drawing one among the plurality of advertisement keywords based on a relevancy value assigned to each term.

13. The method of claim 12, wherein the relevancy value is assigned based on at least one selected from the group consisting of how many times each of the plurality of advertisement keywords occurs in the data, and how close in time an occurrence of each of the plurality of advertisement keywords is to playing of the multimedia content, wherein the more each advertisement keyword occurs, the greater the relevancy value assigned to the advertisement keyword is, wherein the closer in time each advertisement keyword's occurrence is to playing of the multimedia content, the greater the relevancy value assigned to the advertisement keyword is, wherein the relevancy value assigned to each advertisement keyword is the sum of time proximity values of occurrences thereof, wherein the longer a time gap between an occurrence and playing of the multimedia content, the smaller the time proximity value is.

14. The method of claim 1, wherein selecting the advertisement comprises locating the at least one advertisement associated with the advertisement keyword that is sold to at least one advertiser for displaying the at least one advertisement when the advertisement keyword is selected.

15. The method of claim 1, wherein recognizing comprises at least one selected from the group consisting of monitoring types and sizes of data transmission between a server of the website and the user's terminal, monitoring operation of the user's terminal, receiving from a server of the website information about playing or initiating to play the multimedia content in the user's terminal, and receiving from the user's terminal information about playing or initiating to play the multimedia content.

16. The method of claim 15, wherein the types of data transmission comprises streaming, downloading from the server to the user's terminal, uploading from the user's terminal to the server, wherein the information received from the user's terminal or the server comprises at least one selected from the group consisting of a request for streaming or downloading the multimedia content, an acknowledgement of receipt of the request, and a notification of streaming or downloading progress.

17. The method of claim 15, wherein recognizing comprises determining that the multimedia content transmitted from a website is being played or about to be played.

18. The method of claim 1, wherein providing data comprises monitoring user's interactions with the Internet.

19. The method of claim 1, wherein providing data comprises receiving, from the user's terminal, data indicative of user's interactions with the Internet.

20. The method of claim 1, wherein the data represents the user's interactions with the Internet for a predetermined period up to playing of the multimedia content.
